(19) United States
(12) Patent Application Publication
(10) Pub. No.: US 2016/0008721 A1
(43) Pub. Date: Jan. 14, 2016

(54) PROVISION OF GAME CHARACTERS

(71) Applicant: EMPIRE TECHNOLOGY DEVELOPMENT LLC, Wilmington, DE (US)

(72) Inventor: Shuichi KURABAYASHI, Fujisawa-shi (JP)

(73) Assignee: EMPIRE TECHNOLOGY DEVELOPMENT LLC, Wilmington, DE (US)

(21) Appl. No.: 14/769,656

(22) PCT Filed: Dec. 30, 2013
(86) PCT No.: PCT/US13/78257

§ 371 Date: Aug. 21, 2015

(51) Int. Cl. A63F 13/795; A63F 13/44

(52) U.S. Cl. CPC A63F 13/795; A63F 13/44

(57) ABSTRACT

Technologies are generally described for providing at least one opponent character for games. In some examples, a method performed under control of a game server may include calculating a winning probability with regard to a plurality of opponents; selecting at least one of the plurality opponents based at least in part on the calculated winning probability; and providing the selected opponent to be displayed within a predetermined range of at least two player characters that are controlled by respective players that have no known relationship with each other for at least a predetermined amount of time.

### BACKGROUND

Massively multiplayer online role-playing game (MMORPG) is a genre of role-playing video games or web browser-based games in which a very large number of players interact with one another within a virtual game world. As in all RPGs, players assume the role of a character (often in a fantasy world or science-fiction world) and take control over many of that character's actions. MMORPGs are distinguished from single-player or small multi-player online RPGs by the number of players, and by the game's persistent world, which continues to exist and evolve while the player is offline and away from the game.

### SUMMARY

In an example, a method performed under control of a game server may include calculating a winning probability with regard to a plurality of opponents; selecting at least one of the plurality opponents based at least in part on the calculated winning probability; and providing the selected opponent to be displayed within a predetermined range of at least two player characters that are controlled by respective players that have no known relationship with each other for at least a predetermined amount of time.

In another example, a game server may include a probability calculating unit configured to calculate a winning probability with regard to a plurality of opponents; and a controller configured to: select at least one of the plurality opponents based at least in part on the calculated winning probability, and provide the selected opponent to be displayed within a predetermined range of at least two player characters that are controlled by respective players that have no known relationship with each other for a predetermined amount of time.

In yet another example, a computer-readable storage medium having stored thereon computer-executable instructions that, in response to execution, may cause a game server to perform operations including: calculating a winning probability with regard to a plurality of opponents; selecting at least one of the plurality opponents based at least in part on the calculated winning probability; and providing the selected opponent to be displayed within a predetermined range of at least two player characters that are controlled by respective players that have no known relationship with each other for at least a predetermined amount of time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment including at least one end device and a game server, arranged in accordance with at least some embodiments described herein;

FIG. 2 schematically shows an illustrative example of an end device, arranged in accordance with at least some embodiments described herein;

FIG. 3A schematically shows an illustrative example of a player character database, arranged in accordance with at least some embodiments described herein;

FIG. 3B schematically shows an illustrative example of an opponent character database, arranged in accordance with at least some embodiments described herein;

FIG. 4 shows a schematic block diagram illustrating an example architecture for a game server, arranged in accordance with at least some embodiments described herein;

FIG. 5 schematically shows an example flow diagram of a process of a game server for providing an opponent character for a game, arranged in accordance with at least some embodiments described herein;

FIG. 6 illustrates computer program products that may be utilized to provide an opponent character for a game, arranged in accordance with at least some embodiments described herein; and

FIG. 7 is a block diagram illustrating an example computing device that may be utilized to provide an opponent character for a game, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to provision of a game character. Technologies are generally described for a method for selecting an opponent character and providing the selected opponent character to be positioned in the vicinity of player characters in a virtual game space.

In some examples, a game server may be configured to identify multiple opponent character parties, each of which may include at least one opponent character. For example, the opponent character may be a monster character. Further, the game server may be configured to calculate a probability of victory for a player character party that includes two player characters over each of the multiple opponent character parties. That is, the game server may be configured to calculate a probability of victory in case that the two player characters generate a player character party (e.g., a team or a group) and the generated player character party does a battle with each of the multiple opponent character parties. Further, the game server may be configured to calculate a probability of victory for the respective two player characters over each of the multiple opponent character parties. That is, the game server may be configured to calculate a probability of victory in case that each of the two player characters does a battle with each of the multiple opponent character parties alone.

The game server may be further configured to select one opponent character party from among the identified multiple opponent character parties based at least in part on the calculated probability of victory for the player character party over each of the multiple opponent character parties and the calculated probability of victory for the respective two player characters over each of the multiple opponent character parties. For example, but not as a limitation, the game server may be configured to select one opponent character party over which the calculated probability of victory for the player character party is the highest and over which the calculated probability of victory for the respective two player characters is the lowest. Accordingly, the game server may be configured to select one opponent character party which is not conquered by the respective two player characters but is conquered by the player character party including the two player characters. The game server may be configured to then provide, to an end device, the selected opponent character party to be displayed in the vicinity of the two player characters in a virtual game space.

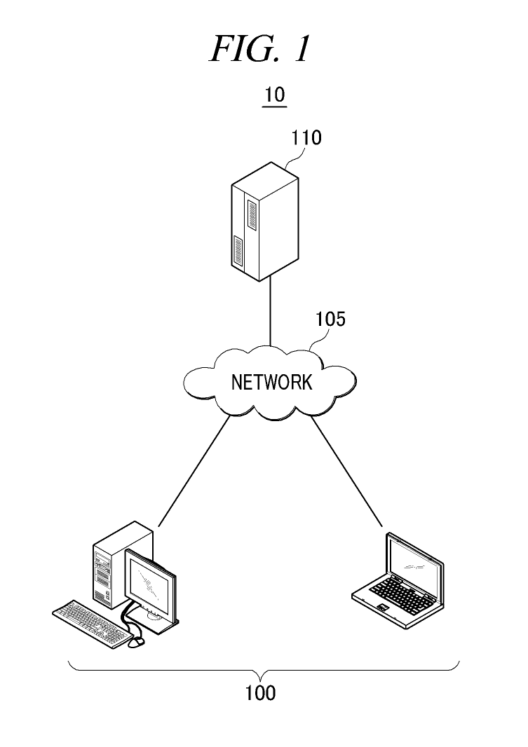

FIG. 1 schematically shows an illustrative example of an environment 10 including at least one end device 100 and a game server 110, arranged in accordance with at least some embodiments described herein. As illustrated in FIG. 1, at least one end device 100 and game server 110 may be connected to each other via a network 105.

Respective one of at least one end device 100 may refer to a notebook computer; a personal computer; a smart phone; a tablet computer; a phablet device; and/or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

By way of example, but not as a limitation, network 105 between at least one end device 100 and game server 110 may include all kinds of wireless networks, non-limiting examples of which may include a mobile radio communication network, a satellite network, a bluetooth, WiBro (Wireless Broadband Internet), Mobile WiMAX, HSDPA (High Speed Downlink Packet Access) or the like.

Game server 110 may refer to one or more servers that are hosted on or by a game service providing organization or entity to at least one end device 100. Game server 110 may represent one or more servers or other processing apparatuses that may be configured to manage activity histories of multiple game players and game character records controlled by the multiple game players.

In some embodiments, game server 110 may be configured to determine whether each player who logged-in a virtual game service provided by game server 110 is a lonely player, based at least in part on an activity history of each player stored in a database which is communicatively coupled to game server 110. The lonely player may refer to a player who has not participated in any character party or team for at least a predetermined amount of time (e.g., 7 days) and has no known relationship with other players. Game server 110 may be configured to then select players having no known relationship with other players from among all players who logged-in the virtual game service.

Further, game server 110 may be configured to extract, from the database storing records of multiple game characters, information regarding multiple player characters that are controlled by the selected players having no known relationship with other players. By way of example, but not as a limitation, the information regarding the multiple player characters may include a current position of the respective one of the multiple player characters displayed in a virtual game space, a game role for the respective one of the multiple player characters, virtual game attributes for the respective one of the multiple player characters, virtual game skills for the respective one of the multiple player characters, or virtual game items with which the respective one of the multiple player characters are equipped. Game server 110 may be further configured to store the extracted information regarding multiple player characters that are controlled by the selected players having no known relationship with other players in a player character database. Further, game server 110 may be configured to update the player character database, as the information regarding the current position, game role, virtual game attributes, virtual game skills, or virtual game items of the multiple player characters are changed.

Further, game server 110 may be configured to identify multiple player character parties from the player character database that stores the information regarding the multiple player characters controlled by the selected players having no known relationship with other players. Each of the player character parties may include at least two player characters controlled by the players having no known relationship with each other for at least a predetermined amount of time. For example, game server 110 may be configured to generate all possible combinations of player characters controlled by the players having no known relationship with each other. For example, game server 110 may be configured to identify the multiple player character parties by using the below formula 1.

$${}_{n}^{}{C}{}_{m}^{} = \frac{n !}{m ! ( n - m ) !} \qquad [ formula 1 ]$$

The ‘n’ of the formula 1 may represent a number of the player characters that are controlled by the players having no known relationship with each other. Further, the ‘m’ of the formula 1 may represent a number of player characters that constitute a player character party of the multiple player character parties.

Further, game server 110 may be configured to identify multiple opponent character parties from an opponent character database that stores information regarding multiple opponent characters. Each of the opponent character parties may include at least one opponent character. By way of example, but not as a limitation, the information regarding the multiple opponent characters may include a current position of respective one of the multiple opponent characters displayed in a virtual game space, a game species for the respective one of the multiple opponent characters, virtual game attributes for the respective one of the multiple opponent characters, virtual game skills for the respective one of the multiple opponent characters, or virtual game items with which the respective one of the multiple opponent characters are equipped. For example, game server 110 may be configured to identify the multiple opponent character parties by using the below formula 2.

$${}_{k}^{}{H}{}_{r}^{} = \frac{( k + r - 1 ) !}{r ! ( k - 1 ) !} \qquad [ formula 2 ]$$

The ‘k’ of the formula 2 may represent a number of multiple opponent characters, and the ‘r’ of the formula 2 may represent a number of at least one opponent character that constitutes an opponent character party of the multiple opponent character parties.

Game server 110 may be further configured to calculate a winning probability with regard to the multiple opponent characters. In some embodiments, game server 110 may be configured to calculate a probability of victory for each of the respective player character parties which game server 110 identifies from the player character database over each of the multiple opponent character parties which game server 110 identifies from the opponent character database. Further, game server 110 may be configured to calculate a probability of victory for each of the multiple player characters controlled by the players having no known relationship with each other over each of the multiple opponent character parties. By way of example, but not limitation, game server 110 may be configured to calculate the probability of victory for each of the multiple player character parties and the probability of victory for each of the multiple player characters by repeating a well-known computer-based automatic battle function.

Further, game server 110 may be configured to calculate the probability of victory for each of the multiple player character parties and the probability of victory for each of the multiple player characters based at least in part on the information regarding the multiple player characters stored in the player character database and the information regarding the multiple opponent characters stored in the opponent character database. The information regarding the multiple player characters may include a current position, a game role, virtual game attributes, virtual game skills, or virtual game items of respective one of the multiple player characters. Further, the information regarding the multiple opponent characters may include a current position, a game species, virtual game attributes, virtual game skills, or virtual game items of respective one of the multiple opponent characters.

Further, game server 110 may be configured to select at least one opponent character from among the multiple opponent characters based at least in part on the calculated winning probability. In some embodiments, game server 110 may be configured to select at least one opponent character based at least in part on the calculated probability of victory for each of the multiple player character parties and the calculated probability of victory for each of the multiple player characters. For example, but not as a limitation, game server 110 may be configured to determine that the probability of victory for a player character party over an opponent character party that includes at least one opponent character is larger than a first predetermined value stored in a memory. Further, game server 110 may be configured to determine that the probability of victory for respective at least two player characters included in the player character party over the opponent character party that includes the at least one opponent character is smaller than a second predetermined value stored in the memory. Then, game server 110 may be configured to select the at least one opponent character included in the opponent character party. By way of another example, game server 110 may select one opponent character party over which the calculated probability of victory for the player character party is the highest and over which the calculated probability of victory for the respective at least two player characters included in the player character party is the lowest.

Further, game server 110 may be configured to provide, to at least one end device 100, the selected at least one opponent character included in the opponent character party to be displayed within a predetermined range of the at least two player characters displayed in a virtual game space. Game server 110 may be configured to position the at least two player characters within the predetermined range in the virtual game space, and to position the selected at least one opponent character within the predetermined range of the at least two player characters in the virtual game space.

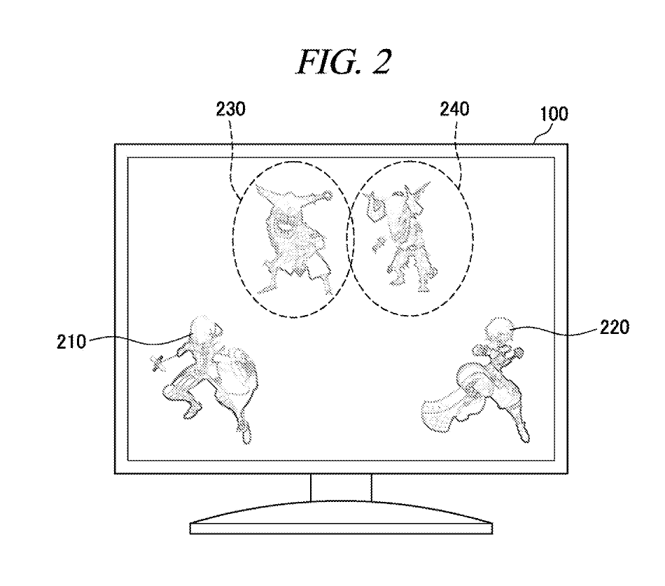

FIG. 2 schematically shows an illustrative example of an end device 100, arranged in accordance with at least some embodiments described herein. In some embodiments, game server 110 may be configured to calculate a probability of victory for a player character party that includes a first player character 210 and a second player character 220 over each of multiple opponent character parties. Further, game server 110 may be configured to calculate a probability of victory for respective first player character 210 and second player character 220 over each of the multiple opponent character parties. First player character 210 and second player character 220 may be controlled by respective players that have no known relationship with each other for at least a predetermined amount of time.

Further, game server 110 may be configured to select a first opponent character 230 and a second opponent character 240 that are included in one opponent character party based at least in part on the calculated probability of victory for the player character party including first player character 210 and second player character 220 and the calculated probability of victory for respective first player character 210 and second player character 220. By way of example, but not as a limitation, game server 110 may be configured to determine that the calculated probability of victory for the player character party including first player character 210 and second player character 220 over the opponent character party including first opponent character 230 and second opponent character 240 is larger than a first predetermined value. Further, game server 110 may be configured to determine that the calculated probability of victory for respective first player character 210 and second player character 220 over the opponent character party including first opponent character 230 and second opponent character 240 is smaller than a second predetermined value. Game server 110 may be configured to then select and provide first opponent character 230 and second opponent character 240 to be displayed within a predetermined range around first player character 210 and second player character 220 in a virtual game space. Therefore, first player character 210 and second player character 220 may be encouraged to organize a player character party in order to conquer first opponent character 230 and second opponent character 240 existing within the predetermined range around first player character 210 and second player character 220.

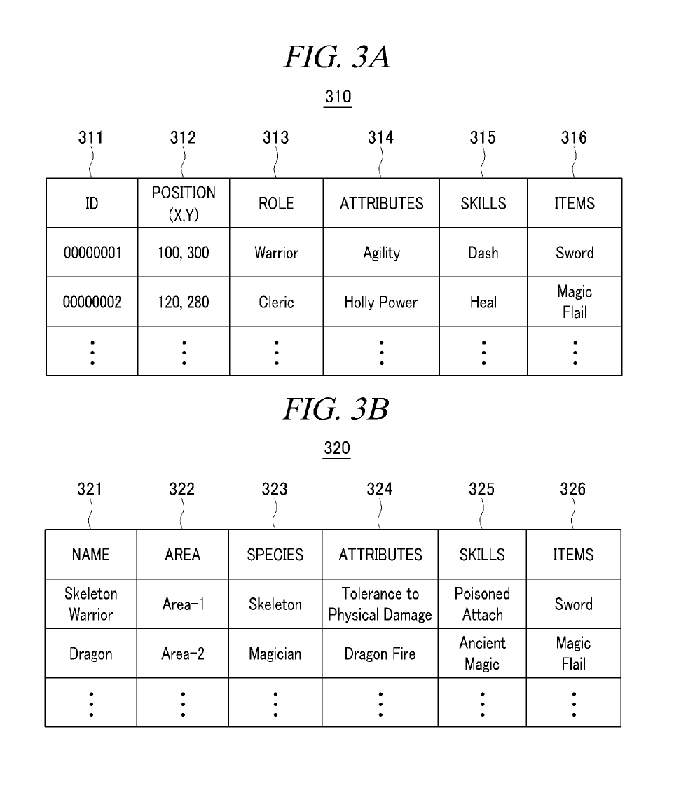

FIG. 3A schematically shows an illustrative example of a player character database 310, arranged in accordance with at least some embodiments described herein. By way of example, but not as a limitation, as depicted in FIG. 3A, player character database 310 may be configured to store information regarding an identifier 311 of respective player characters that are controlled by respective players that have no known relationship with each other for at least a predetermined amount of time. Further, player character database 310 may be configured to store information including a current position 312 of the respective player characters, a game role 313 for the respective player characters, virtual game attributes 314 for the respective player characters, virtual game skills 315 for the respective player characters, or virtual game items 316 with which the respective player characters are equipped.

FIG. 3B schematically shows an illustrative example of an opponent character database 320, arranged in accordance with at least some embodiments described herein. By way of example, but not as a limitation, as depicted in FIG. 3B, opponent character database 320 may be configured to store information including an identifier 321 of respective opponent characters, an area 322 in which the respective opponent characters exist, a game species 323 for the respective opponent characters, virtual game attributes 324 for the respective opponent characters, virtual game skills 325 for the respective opponent characters, or virtual game items 326 with which the respective opponent characters are equipped.

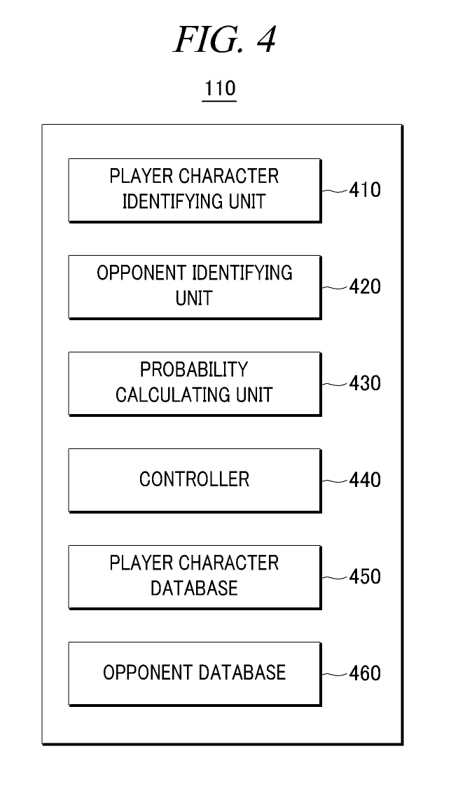

FIG. 4 shows a schematic block diagram illustrating an example architecture for a game server 110, arranged in accordance with at least some embodiments described herein. As depicted in FIG. 4, game server 110 may include a player character identifying unit 410, an opponent identifying unit 420, a probability calculating unit 430, a controller 440, a player character database 450, and an opponent database 460. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of player character identifying unit 410, opponent identifying unit 420, probability calculating unit 430, controller 440, player character database 450, and opponent database 460 may be included in an instance of an application hosted on game server 110.

Player character identifying unit 410 may be configured to identify multiple player character parties from multiple player characters stored in player character database 450. Each of the player character parties may include at least two player characters controlled by players having no known relationship with each other for at least a predetermined amount of time. For example, player character identifying unit 410 may be configured to identify the multiple player character parties by using the below formula 1.

$${}_{n}^{}{C}{}_{m}^{} = \frac{n !}{m ! ( n - m ) !} \qquad [ formula 1 ]$$

The ‘n’ of the formula 1 may represent a number of the multiple player characters that are controlled by the players having no known relationship with each other. Further, the ‘m’ of the formula 1 may represent a number of player characters that constitute a player character party of the multiple player character parties.

Opponent identifying unit 420 may be configured to identify multiple opponent character parties from multiple opponent characters stored in opponent database 460. Each of the opponent character parties may include at least one opponent character. For example, opponent identifying unit 420 may be configured to identify the multiple opponent character parties by using the below formula 2.

$${}_{k}^{}{H}{}_{r}^{} = \frac{( k + r - 1 ) !}{r ! ( k - 1 ) !} \qquad [ formula 2 ]$$

The ‘k’ of the formula 2 may represent a number of the multiple opponent characters, and the ‘r’ of the formula 2 may represent a number of at least one opponent character that constitutes an opponent character party of the multiple opponent character parties.

Probability calculating unit 430 may be configured to calculate a winning probability with regard to the multiple opponent characters. In some embodiments, probability calculating unit 430 may be configured to calculate a probability of victory for each of the multiple player character parties, which player character identifying unit 410 identifies, over each of the multiple opponent character parties, which opponent identifying unit 420 identifies. Further, probability calculating unit 430 may be configured to calculate a probability of victory for each of the multiple player characters controlled by the players having no known relationship with each other over each of the multiple opponent character parties. By way of example, but not limitation, probability calculating unit 430 may be configured to calculate the probability of victory for each of the respective player character parties and the probability of victory for each of the respective player characters by repeating a well-known computer-based automatic battle function.

Further, probability calculating unit 430 may be configured to calculate the probability of victory for each of the multiple player character parties and the probability of victory for each of the multiple player characters based at least in part on information regarding the multiple player characters stored in player character database 450 and information regarding the multiple opponent characters stored in opponent database 460. For example, but not as a limitation, the information regarding the multiple player characters may include a current position, a game role, virtual game attributes, virtual game skills, or virtual game items of the multiple player characters. Further, the information regarding the multiple opponent characters may include a current position, a game species, virtual game attributes, virtual game skills, or virtual game items of the multiple opponent characters.

Further, probability calculating unit 430 may be configured to determine that the probability of victory for a player character party among the multiple player character parties over an opponent character party including at least one opponent character among the multiple opponent character parties is larger than a first predetermined value. Further, game server 110 may be configured to determine that the probability of victory for respective at least two player character included in the player character party over the opponent character party that includes the at least one opponent character is smaller than a second predetermined value.

Controller 440 may be configured to select at least one opponent character from among the multiple opponent characters based at least in part on the calculated winning probability. In some embodiments, controller 440 may be configured to select at least one opponent character based at least in part on the calculated probability of victory for each of the multiple player character parties and the calculated probability of victory for each of the multiple player characters. For example, controller 440 may be configured to select the opponent character party including the at least one opponent character, when probability calculating unit 430 determines that the probability of victory for the player character party including the at least two player characters over the opponent character party is larger than the first predetermined value and the probability of victory for the respective at least two player characters included in the player character party over the opponent character party is smaller than the second predetermined

Further, controller 440 may be configured to provide, to at least one end device 100, the selected at least one opponent character included in the opponent character party to be displayed within a predetermined range of the at least two player characters displayed in a virtual game space. Controller 440 may be configured to position the at least two player characters within the predetermined range in the virtual game space, and to position the selected at least one opponent character within the predetermined range of the at least two player characters in the virtual game space.

Further, controller 440 may be configured to determine whether each player who logged-in a virtual game service provided by game server 110 has not participated in any character party for at least a predetermined amount of time (e.g., 7 days) and has no known relationship with other players based at least in part on activity histories of respective players. Controller 440 may be configured to then select players having no known relationship with other players from among all players who logged-in the virtual game service.

Further, controller 440 may be configured to extract information regarding multiple player characters that are controlled by the selected players having no known relationship with other players. By way of example, but not as a limitation, the information regarding the multiple player characters may include a current position of the respective one of the multiple player characters displayed in a virtual game space, a game role for the respective one of the multiple player characters, virtual game attributes for the respective one of the multiple player characters, virtual game skills for the respective one of the multiple player characters, or virtual game items with which the respective one of the multiple player characters are equipped. Controller 440 may be further configured to store the extracted information regarding multiple player characters that are controlled by the selected players having no known relationship with other players in player character database 450. Further, controller 440 may be configured to update player character database 450, as the information regarding the current position, game role, virtual game attributes, virtual game skills, or virtual game items of the multiple player characters are changed.

Player character database 450 may be configured to store the information regarding the multiple player characters that are controlled by the selected players having no known relationship with other players.

Opponent database 460 may be configured to store information regarding multiple opponent characters. By way of example, but not as a limitation, the information regarding the multiple opponent characters may include a current position of respective one of the multiple opponent characters, a game species for the respective one of the multiple opponent characters, virtual game attributes for the respective one of the multiple opponent characters, virtual game skills for the respective one of the multiple opponent characters, or virtual game items with which the respective one of the multiple opponent characters are equipped.

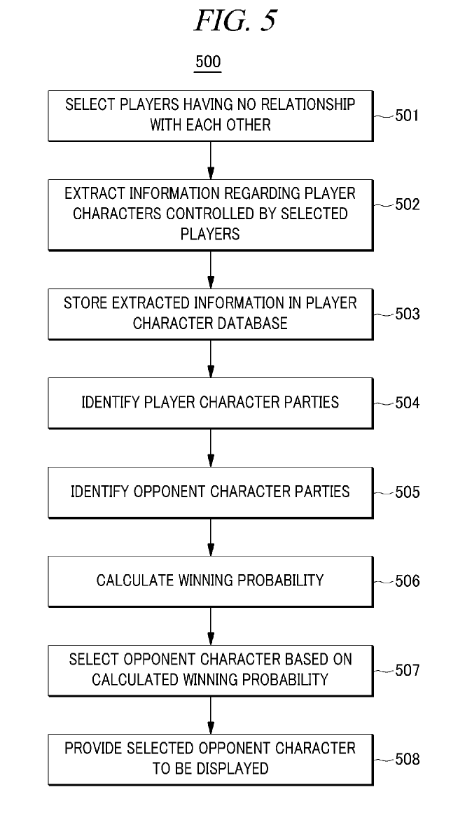

FIG. 5 schematically shows an example flow diagram of a process 500 of a game server 110 for providing an opponent character for a game, arranged in accordance with at least some embodiments described herein. The process in FIG. 5 may be implemented in environment 10 including at least one end device 100 and game server 110, as illustrated in FIG. 1. An example process may include one or more operations, actions, or functions as illustrated by one or more blocks 501, 502, 503, 504, 505, 506, 507 and/or 508. Although illustrated as discrete blocks, various blocks may be divided into additional blocks, combined into fewer blocks, or eliminated, depending on the desired implementation. Processing may begin at block 501.

At block 501 (Select Players Having No Relationship with Each Other), game server 110 may select players having no known relationship with other players from among all players who logged-in a virtual game service. In some embodiments, game server 110 may determine that each player who logged-in the virtual game service provided by game server 110 has not participated in any character party for at least a predetermined amount of time (e.g., 7 days) and has no known relationship with other players based at least in part on activity history of each player. Then, game server 110 may select players having no known relationship with other players. Processing may proceed from block 501 to block 502.

At block 502 (Extract Information Regarding Player Characters Controlled by Selected Players), game server 110 may extract information regarding multiple player characters that are controlled by the players selected at block 501. By way of example, the information regarding the multiple player characters may include a current position of the respective player characters, a game role for the respective player characters, virtual game attributes for the respective player characters, virtual game skills for the respective player characters, or virtual game items with which the respective player characters are equipped. Processing may proceed from block 502 to block 503.

At block 503 (Store Extracted Information in Player Character Database), game server 110 may store the extracted information regarding multiple player characters that are controlled by the selected players having no known relationship with other players in a player character database. Processing may proceed from block 503 to block 504.

At block 504 (Identify Player Character Parties), game server 110 may identify multiple player character parties from the player character database. Each of the player character parties may include at least two player characters controlled by the respective players having no known relationship with each other. Processing may proceed from block 504 to block 505.

At block 505 (Identify Opponent Character Parties), game server 110 may identify multiple opponent character parties from an opponent character database that stores information regarding multiple opponent characters. Each of the opponent character parties may include at least one opponent character. Processing may proceed from block 505 to block 506.

At block 506 (Calculate Winning Probability), game server 110 may calculate a winning probability with regard to the multiple opponent characters. In some embodiments, game server 110 may calculate a probability of victory for each of the multiple player character parties identified at block 504 over each of the multiple opponent character parties identified at block 505. Further, game server 110 may calculate a probability of victory for each of the multiple player characters over each of the multiple opponent character parties identified at block 505. Further, game server 110 may determine that the probability of victory for a player character party including at least two player characters among the multiple player character parties over an opponent character party including at least one opponent character among the multiple opponent character parties is larger than a first predetermined value. Further, game server 110 may determine that the probability of victory for the respective at least two player characters included in the player character party over the opponent character party that includes the at least one opponent character is smaller than a second predetermined value. Processing may proceed from block 506 to block 507.

At block 507 (Select Opponent Character Based on Calculated Winning Probability), game server 110 may select at least one opponent character from among the multiple opponent characters based at least in part on the winning probability calculated at block 506. In some embodiments, game server 110 may select the at least one opponent character included in the opponent character party based at least in part on the calculated probability of victory for each of the multiple player character parties and the calculated probability of victory for each of the multiple player characters. For example, game server 110 may select the opponent character party including the at least one opponent character, when,at block 506, game server 110 determines that the probability of victory for the player character party over the opponent character party is larger than the first predetermined value and the probability of victory for the respective at least two player characters included in the player character party over the opponent character party is smaller than the second predetermined Processing may proceed from block 507 to block 508.

Block 508 (Provide Selected Opponent Character to Be Displayed), game server 110 may provide, to at least one end device 100, the selected at least one opponent character included in the opponent character party to be displayed within a predetermined range of the at least two player characters displayed in a virtual game space. Game server 110 may position the at least two player characters within the predetermined range in the virtual game space, and to position the selected at least one opponent character within the predetermined range of the at least two player characters in the virtual game space.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

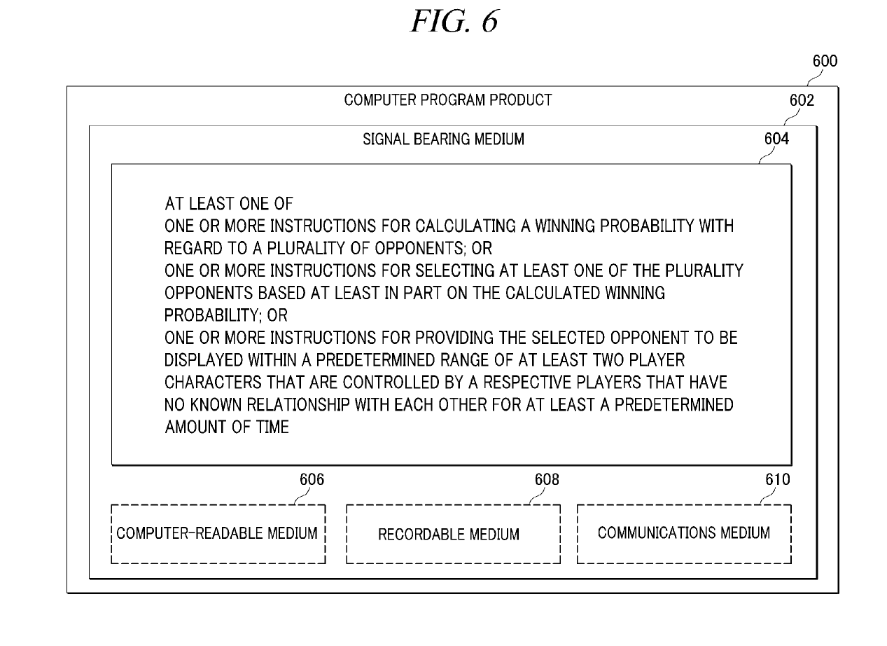

FIG. 6 illustrates computer program products that may be utilized to provide an opponent character for a game, arranged in accordance with at least some embodiments described herein. Program product 600 may include a signal bearing medium 602. Signal bearing medium 602 may include one or more instructions 604 that, when executed by, for example, a processor, may provide the functionality described above with respect to FIGS. 1-5. By way of example, instructions 604 may include: one or more instructions for calculating a winning probability with regard to a plurality of opponents; one or more instructions for selecting at least one of the plurality opponents based at least in part on the calculated winning probability; one or more instructions for providing the selected opponent to be displayed within a predetermined range of at least two player characters that are controlled by respective players that have no known relationship with each other for at least a predetermined amount of time. Thus, for example, referring to FIG. 5, game server 110 may undertake one or more of the blocks shown in FIG. 5 in response to instructions 604.

In some implementations, signal bearing medium 602 may encompass a computer-readable medium 606, such as, but not limited to, a hard disk drive, a CD, a DVD, a digital tape, memory, etc. In some implementations, signal bearing medium 602 may encompass a recordable medium 608, such as, but not limited to, memory, read/write (R/W) CDs, R/W DVDs, etc. In some implementations, signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, program product 600 may be conveyed to one or more modules of game server 110 by an RF signal bearing medium 602, where the signal bearing medium 602 is conveyed by a wireless communications medium 610 (e.g., a wireless communications medium conforming with the IEEE 802.11 standard).

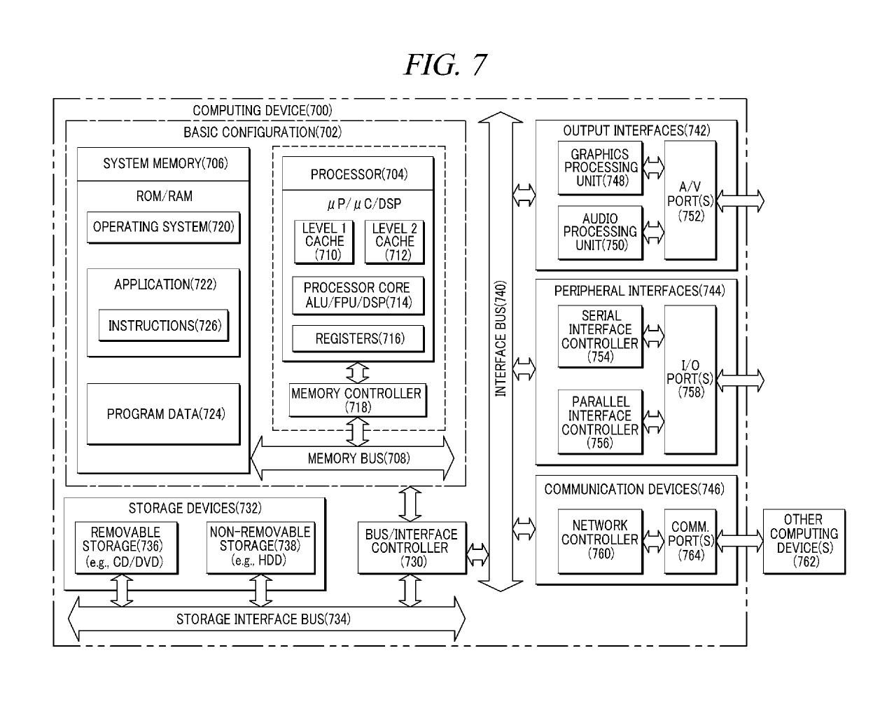

FIG. 7 is a block diagram illustrating an example computing device that may be utilized to provide an opponent character for a game, arranged in accordance with at least some embodiments described herein. In these examples, elements of computing device 700 may be arranged or configured for a device. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, an application 722, and program data 724. Application 722 may include instructions 726 that may be arranged to perform the functions as described herein including the actions described with respect to game server architecture as shown in FIG. 4 or including the actions described with respect to the flow charts shown in FIG. 5. In some examples, application 722 may be arranged to operate with program data 724 on an operating system 720 such that the schemes for providing game characters as described herein may be provided.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a game server, comprising:
calculating a winning probability with regard to a plurality of opponents;
selecting at least one of the plurality opponents based at least in part on the calculated winning probability; and
positioning the selected opponent to be displayed within a predetermined range of at least two player characters that are controlled by respective players that have no known relationship with each other for at least a predetermined amount of time.

2. The method of claim 1, further comprising:
identifying a plurality of player character parties from a player character database that stores information regarding a plurality of player characters that are controlled by players having no known relationship with each other; and
identifying a plurality of opponent parties from an opponent database that stores information regarding the plurality of opponents,
wherein the selected at least one opponent is included in one opponent party of the plurality of opponent parties, and
wherein the at least two player characters are included in one player character party of the plurality of player character parties.

3. The method of claim 1, wherein the positioning includes:
positioning the at least two player characters within the predetermined range in a virtual game space, and
positioning the selected opponent within the predetermined range of the at least two player characters in the virtual game space.

4. The method of claim 2, wherein the calculating of the winning probability includes:
calculating a probability of victory for each of the respective plurality of player character parties over each of the plurality of opponent parties; and
calculating a probability of victory for each of the respective plurality of player characters over each of the plurality of opponent parties,
wherein the selecting is based at least in part on the calculated probability of victory for each of the respective plurality of player character parties and the calculated probability of victory for each of the respective plurality of player characters.

5. The method of claim 4, further comprising:
determining that the probability of victory for the one player character party, which includes the at least two player characters, over the one opponent party, which includes the at least one opponent, is larger than a first predetermined value; and
determining that the probability of victory for the at least two player characters over the one opponent party is smaller than a second predetermined value.

6. The method of claim 4, wherein the calculating of the probability of victory for each of the respective plurality of player character parties and the calculating of the calculated probability of victory for each of the respective plurality of player characters are performed by repeating a computer-based automatic battle function.

7. The method of claim 2, further comprising:
selecting the players having no known relationship with each other based at least in part on activity histories of the respective players;
extracting the information regarding the plurality of player characters that are controlled by the selected players; and
storing the extracted information regarding the plurality of player characters in the player character database.

8. The method of claim 7, wherein the information regarding the plurality of player characters includes at least one of a current position of the respective player characters displayed in the virtual game space, virtual game roles for each of the plurality of player characters, virtual game attributes of the plurality of player characters, virtual game skills of the plurality of player characters, or virtual game items with which the plurality of player characters are equipped.

9. The method of claim 2, wherein the identifying of the plurality of player character parties is calculated from:
$${}_{n}^{}{C}{}_{m}^{} = \frac{n !}{m ! ( n - m ) !} ,$$
wherein ‘n’ represents a number of the plurality of player characters, and ‘m’ represents a number of player characters that constitute a player character party of the plurality of player character parties,
wherein the identifying of the plurality of opponent parties is calculated from:
$${}_{k}^{}{H}{}_{r}^{} = \frac{( k + r - 1 ) !}{r ! ( k - 1 ) !}$$
wherein ‘k’ represents a number of the plurality of opponents, and ‘r’ represents a number of at least one opponent that constitutes an opponent party of the plurality of opponent parties.

10. A game server, comprising:
a probability calculating unit configured to calculate a winning probability with regard to a plurality of opponents; and
a controller configured to:
select at least one of the plurality opponents based at least in part on the calculated winning probability, and
position the selected opponent to be displayed within a predetermined range of at least two player characters that are controlled by respective players that have no known relationship with each other for a predetermined amount of time.

11. The game server of claim 10, further comprising:
a player character database configured to store information regarding a plurality of player characters that are controlled by players having no known relationship with each other;
an opponent database configured to store information regarding the plurality of opponents;
a player character identifying unit configured to identify a plurality of player character parties from the player character database; and
an opponent identifying unit configured to identify a plurality of opponent parties from the opponent database,
wherein the selected at least one opponent is included in one opponent party of the plurality of opponent parties, and
wherein the at least two player characters are included in one player character party of the plurality of player character parties.

12. The game server of claim 10, wherein the controller is further configured to:
position the at least two player characters within the predetermined range in a virtual game space, and
position the selected opponent within the predetermined range of the at least two player characters in the virtual game space.

13. The game server of claim 11, wherein the probability calculating unit is configured to calculate the winning probability by:
calculating a probability of victory for each of the respective plurality of player character parties over each of the plurality of opponent parties; and
calculating a probability of victory for each of the respective plurality of player characters over each of the plurality of opponent parties, and
wherein the controller is configured to select the at least one opponent based on the calculated probability of victory for each of the respective plurality of player character parties and the calculated probability of victory for each of the respective plurality of player characters.

14. The game server of claim 13, wherein the probability calculating unit is further configured to:
determine that the probability of victory for the one player character party, which includes the at least two player characters, over the one opponent party, which includes the at least one opponent, is larger than a first predetermined value, and
determine that the probability of victory for the at least two player characters over the one opponent party is smaller than a second predetermined value.

15. The game server of claim 13, wherein the probability calculating unit is configured to calculate the probability of victory for each of the respective plurality of player character parties and the probability of victory for each of the respective plurality of player characters by repeating a computer-based automatic battle function.

16. The game server of claim 11, wherein the controller is further configured to:
select the players having no known relationship with each other based at least in part on activity histories of the respective players;
extract the information regarding the plurality of player characters that are controlled by the selected players; and
store the extracted information regarding the plurality of player characters in the player character database.

17. The game server of claim 16, wherein the information regarding the plurality of player characters includes at least one of a current position of the respective player characters displayed in a virtual game space, virtual game roles for each of the plurality of player characters, virtual game attributes of the plurality of player characters, virtual game skills of the plurality of player characters, or virtual game items with which the plurality of player characters are equipped.

18. The game server of claim 11, wherein the player character identifying unit is further configured to identify the plurality of player character parties from:
$${}_{n}^{}{C}{}_{m}^{} = \frac{n !}{m ! ( n - m ) !} ,$$
wherein ‘n’ represents a number of the plurality of player characters, and ‘m’ represents a number of player characters that constitute a player character party of the plurality of player character parties,
wherein the opponent identifying unit is configured to identify the plurality of opponent parties from:
$${}_{k}^{}{H}{}_{r}^{} = \frac{( k + r - 1 ) !}{r ! ( k - 1 ) !}$$
wherein ‘k’ represents a number of the plurality of opponents, and ‘r’ represents a number of at least one opponent that constitutes an opponent party of the plurality of opponent parties.

19. A non-transitory computer-readable storage medium having stored thereon computer-executable instructions that, in response to execution, cause a game server to perform operations, comprising:
calculating a winning probability with regard to a plurality of opponents;
selecting at least one of the plurality opponents based at least in part on the calculated winning probability; and
positioning the selected opponent to be displayed within a predetermined range of at least two player characters that are controlled by respective players that have no known relationship with each other for at least a predetermined amount of time.

20. The computer-readable storage medium of claim 19, wherein the operations further comprise:
identifying a plurality of player character parties from a player character database that stores information regarding a plurality of player characters that are controlled by players having no known relationship with each other; and
identifying a plurality of opponent parties from an opponent database that stores information regarding the plurality of opponents,
wherein the selected at least one opponent is included in one opponent party of the plurality of opponent parties, and
wherein the at least two player characters are included in one player character party of the plurality of player character parties.
